(19) United States
(12) Patent Application Publication
(10) Pub. No.: US 2020/0169691 A1
(43) Pub. Date: May 28, 2020

(54) METHOD AND APPARATUS FOR LUMINANCE-ADAPTIVE OPTO-ELECTRICAL/ELECTRO-OPTICAL TRANSFER

(71) Applicants: ELECTRONICS AND TELECOMMUNICATIONS RESEARCH INSTITUTE, Daejeon (KR); KOREA ADVANCED INSTITUTE OF SCIENCE AND TECHNOLOGY, Daejeon (KR)

(72) Inventors: Se-Yoon JEONG, Daejeon (KR); Min Hyuk KIM, Daejeon (KR); Shinyoung YI, Daejeon (KR); Jung-Won KANG, Daejeon (KR); Hui-Yong KIM, Daejeon (KR); Hakyeong KIM, Daejeon (KR)

(73) Assignees: ELECTRONICS AND TELECOMMUNICATIONS RESEARCH INSTITUTE, Daejeon (KR); KOREA ADVANCED INSTITUTE OF SCIENCE AND TECHNOLOGY, Daejeon (KR)

(21) Appl. No.: 16/695,886

(22) Filed: Nov. 26, 2019

(30) Foreign Application Priority Data
Nov. 27, 2018 (KR) 10-2018-0148957
Nov. 21, 2019 (KR) 10-2019-0150312

(51) Int. Cl. H04N 7/00; H04N 5/58

(52) U.S. Cl. CPC H04N 7/005; H04N 5/58

(57) ABSTRACT

Disclosed herein are a method and apparatus for luminance-adaptive opto-electrical transfer and luminance-adaptive electro-optical transfer. For video transmission and compression, opto-electrical transfer and electro-optical transfer are required. The surround luminance and luminance range of an image are taken into consideration when performing opto-electrical transfer and electro-optical transfer. An opto-electrical transfer function may be derived based on a contrast sensitivity function that takes into consideration the surround luminance of an image. Also, parameters relevant to surround luminance may be signaled from an encoding apparatus to a decoding apparatus, and an electro-optical transfer function may be derived based on the parameters.

### CROSS REFERENCE TO RELATED APPLICATIONS

This application claims the benefit of Korean Patent Application Nos. 10-2018-0148957, filed Nov. 27, 2018, and 10-2019-0150312, filed Nov. 21, 2019, which are hereby incorporated by reference in their entireties into this application.

### BACKGROUND OF THE INVENTION

### 1. Technical Field

The following embodiments relate generally to a method and apparatus for opto-electrical/electro-optical transfer, and more particularly, to a method and apparatus for providing luminance-adaptive opto-electrical/electro-optical transfer functions to realize High-Dynamic Range (HDR) video transmission and compression.

### 2. Description of the Related Art

High-Dynamic Range (HDR) video preprocessing is a process for converting an optical signal into an electrical signal.

The optical signal has continuous real numbers, but the real number values of the optical signal are converted into discrete values for compression and transmission through digital signal processing.

During this conversion process, opto-electrical transfer quantization is applied to a continuous optical signal in order to convert such a continuous optical signal into discrete electrical signals.

In current HDR video technology, in an opto-electrical transfer process, quantization at a bit depth of 10 bits or 12 bits has been adopted.

Such quantization uses non-linear transfer based on a human visual perception model, rather than using a simple linear transfer, when converting an optical signal into an electrical signal.

When a non-linear transfer based on the perception model is used, quantization may be performed at a bit depth lower than that of linear transfer without causing degradation of image quality attributable to quantization.

Hereinafter, “opto-electrical transfer quantization” may be abbreviated as “opto-electrical transfer”. Also, “electro-optical transfer” may stand for “electro-optical transfer inverse quantization”.

In HDR opto-electrical transfer, there is a Perceptual Quantizer (PQ), which is the most widely used standard scheme.

When PQ technology was initially proposed, the use of a bit depth of 12 bits was proposed. In other words, it may be considered that PQ technology was designed to enable operation without causing degradation of image quality when a bit depth of 12 bits is used.

However, in most application platforms that use HDR video, such as Ultra-High Definition Television (UHDTV), a bit depth of 10 bits is used as a standard depth. For this reason, the use of a bit depth of 10 bits has been finally fixed even for PQ.

Therefore, in current PQ technology that uses a bit depth of 10 bits, degradation of image quality may occur due to an insufficient number of quantization bits. However, most HDR image transmission standards adopt a bit depth of 10 bits as a standard.

A visual perception model on which existing HDR opto-electrical transfer technology is based is a model independently functioning without considering the scene of an image. Existing HDR opto-electrical transfer technology does not consider a change in the visual perception of a human being depending on the scene of the image. In other words, the existing HDR opto-electrical transfer technology uses a fixed visual perception model. Since such a fixed visual perception model is used, there is a strong possibility that degradation of image quality will occur during an opto-electrical transfer process depending on the existing HDR opto-electrical transfer technology. Further, when a bit depth of 10 bits is used, degradation of image quality may become serious.

### SUMMARY OF THE INVENTION

An embodiment is intended to provide a method and apparatus that perform opto-electrical transfer for converting an optical signal into an electrical signal in HDR video processing.

An embodiment is intended to provide a method and apparatus that perform electro-optical transfer for converting an electrical signal into an optical signal in HDR video processing.

An embodiment is intended to provide a method and apparatus that perform an HDR opto-electrical transfer for reducing degradation of image quality based on a luminance-adaptive visual perception model.

An embodiment is intended to provide a method and apparatus that perform HDR electro-optical transfer, which is the reverse process of HDR opto-electrical transfer.

In accordance with an aspect, there is provided a video-processing method, including performing opto-electrical transfer on an image using an opto-electrical transfer function, wherein a result of the opto-electrical transfer function is dependent on a surround luminance of the image.

The opto-electrical transfer function may be based on a contrast sensitivity function depending on the surround luminance of the image.

The contrast sensitivity function depending on the surround luminance of the image may be a product of a contrast sensitivity function irrelevant to the surround luminance and a correction factor for considering the surround luminance

The surround luminance may be a mean of luminance values of a surrounding area of the image.

The surround luminance may be a geometric mean of values of all pixels of the image.

The result of the opto-electrical transfer function may be dependent on a luminance range of the image.

Progressions corresponding to values of the opto-electrical transfer function may be acquired using an interval variable.

The interval variable may be a variable used to maintain intervals between the progressions and a threshold at a uniform value.

The opto-electrical transfer function may be derived using a parameter.

The parameter may include one or more of a bit depth, a luminance range, a surround luminance, and a contrast sensitivity peak function in which the surround luminance is taken into consideration.

The video-processing method may further include transmitting a bitstream to a decoding apparatus.

The bitstream may include the parameter.

In accordance with another aspect, there is provided a video-processing method, including performing electro-optical transfer on an image using an electro-optical transfer function, wherein a result of the electro-optical transfer function is dependent on a surround luminance of the image.

The electro-optical transfer function may be based on a contrast sensitivity function in which the surround luminance of the image is taken into consideration.

The result of the electro-optical transfer function may be dependent on a luminance range of the image.

The surround luminance may be a mean of luminance values of a surrounding area of the image.

The surround luminance may be a geometric mean of values of all pixels of the image.

The result of the electro-optical transfer function may be dependent on a luminance range of the image.

The electro-optical transfer function may be derived using a parameter.

The parameter may include one or more of a bit depth, a luminance range, a surround luminance, and a contrast sensitivity peak function in which the surround luminance is taken into consideration.

The video-processing method may further include receiving a bitstream from an encoding apparatus, wherein the bitstream includes the parameter.

In accordance with a further aspect, there is provided a computer-readable storage medium storing a bitstream, the bitstream including a parameter, wherein the parameter is used to derive an electro-optical transfer function, and electro-optical transfer is performed on an image using the electro-optical transfer function.

### BRIEF DESCRIPTION OF THE DRAWINGS

FIG. 1 illustrates an encoding apparatus according to an embodiment;

FIG. 2 illustrates a decoding apparatus according to an embodiment;

FIG. 3 is a flowchart of video encoding according to an embodiment;

FIG. 4 is a flowchart of video decoding according to an embodiment;

FIG. 5 is a graph illustrating a comparison between EOTFs used in a Perceptual Quantizer (PQ) and a Standard Dynamic Range (SDR) according to an example;

FIG. 6 illustrates the occurrence of degradation of image quality in opto-electrical transfer, which uses a 10-bit PQ and a 12-bit PQ, according to an example;

FIG. 7 illustrates a surrounding area and stimuli according to an example;

FIG. 8 illustrates contrast sensitivity depending on the intensities of stimuli according to an example;

FIG. 9 illustrates contrast sensitivity depending on luminance according to an example;

FIG. 10 illustrates pseudocode for electro-optical transfer and opto-electrical transfer according to an example;

FIG. 11 illustrates transfer functions in which a luminance range is taken into consideration according to an example;

FIG. 12 illustrates a table indicating performance indices according to an example;

FIG. 13 illustrates a change in a performance index when a transfer function is determined using a Contrast Sensitivity Function (CSF) in which surround luminance is taken into consideration; and

FIG. 14 illustrates parameter signaling of a luminance-adaptive transfer function according to an embodiment.

### DESCRIPTION OF THE PREFERRED EMBODIMENTS

Detailed descriptions of the following exemplary embodiments will be made with reference to the attached drawings illustrating specific embodiments as examples. These embodiments are fully described in detail so that those skilled in the art can practice the embodiments. It should be understood that various embodiments are different from each other, but they do not need to be mutually exclusive. For example, specific shapes, structures, and features described here in relation to an embodiment may be implemented in other embodiments without departing from the spirit and scope of the present disclosure. Further, it should be understood that the locations or arrangement of individual components in each disclosed embodiment can be changed without departing from the spirit and scope of the embodiment. Therefore, the detailed description, which will be made later, is not intended to be taken in a restrictive sense, and the scope of exemplary embodiments should be limited only by the scopes of the accompanying claims and equivalents thereof if the proper description thereof is made.

Similar reference numerals in the drawings are used to designate identical or similar functions in various aspects. The shapes, sizes, etc. of components in the drawings may be exaggerated to make the description clear.

The terms used in the embodiments are merely used to describe specific embodiments, and are not intended to limit the present disclosure. In the embodiments, a singular expression includes a plural expression unless a description to the contrary is specifically pointed out in context. In the present specification, it should be understood that the terms “comprises” and/or “comprising” are merely intended to indicate that components, steps, operations, and/or elements are present, and additional configurations are included in the scope of the practice of exemplary embodiments or the technical spirit of the exemplary embodiments, and are not intended to exclude the possibility that one or more other components, steps, operations, and/or elements will be present or added. It should be understood that “connected” or “coupled” refers not only to one component being directly connected or coupled with another component, but also to indirect coupling with another component through an intermediate component.

It will be understood that, although the terms “first” and “second” may be used herein to describe various components, these components should not be limited by these terms. These terms are only used to distinguish one component from other components. For instance, a first component discussed below could be termed a second component without departing from the scope of the disclosure. Similarly, a second component can also be termed a first component.

Also, the components present in the embodiments may be independently illustrated so as to indicate different characteristic functions, but this does not mean that each component is necessarily implemented as a separate hardware or software constituent unit. That is, respective components are merely separately listed for convenience of description. For example, at least two of the components may be integrated into a single component. Also, a single component may be separated into a plurality of components. Embodiments in which individual components are integrated or separated are also included in the scope of the disclosure without departing from the essential features of the disclosure.

Further, some components are not essential components for performing essential functions, but are merely optional components for improving functionality. The embodiments may be implemented to include only essential components required in order to implement the essence of the embodiments. For example, a structure from which optional components, such as a component used only to improve performance, are excluded may also be included in the scope of the disclosure.

Embodiments of the present disclosure are described with reference to the accompanying drawings in order to describe the present disclosure in detail so that those having ordinary knowledge in the technical field to which the present disclosure pertains can easily practice the present disclosure. In the following description of the present disclosure, detailed descriptions of known configurations or functions which are deemed to make the gist of the present disclosure obscure will be omitted.

A Perceptual Quantizer (PQ) may derive an Opto-Electrical Transfer Function (OETF) from a Contrast Sensitivity Function (CSF), which is one of human visual perception models.

A PQ may use a fixed CSF without considering the characteristics of images. Also, a processible Dynamic Range (DR) of CSF used in the PQ may be fixed at a range from 10⁻⁶ to 10⁴. That is, a visual perception model used in opto-electrical transfer quantization technology for HDR video may be a model that independently functions regardless of the features of the scene of an image, or may be a model that is designed to function at a 12-bit depth without causing degradation of image quality.

However, since, in most current HDR video application platforms, 10-bit depth has been adopted as a standard, the PQ may not provide sufficient image quality at the 10-bit depth.

Therefore, there is required technology that prevents degradation of image quality or minimizes degradation of image quality to a negligible level during an opto-electrical transfer (quantization) process while using a 10-bit depth.

Perception of image quality by a viewer may be determined based on a human visual perception model, especially CSF, indicating perceptible contrast in a pattern.

A human CSF may change depending on the surround brightness (luminance) of the scene of an image. Therefore, in order to more accurately represent human visual perception, surround luminance of a scene must be able to be taken into consideration in contrast sensitivity. Accordingly, when opto-electrical transfer quantization is performed based on a scene-luminance-adaptive CSF, better perceptual image quality may be achieved using a smaller number of bits.

Therefore, compared to a PQ function, which is designed based on a CSF but does not reflect changes depending on the surround luminance of a scene, the technology according to the embodiment may perform luminance-adaptive electro-optical transfer on an HDR image by applying a CSF that changes depending on the surround luminance of a scene.

The maximum luminance of a DR used in HDR video content creation may approximately range from about 10³ to 4×10³ cd/m². Considering the maximum luminance, the opto-electrical transfer may be more efficiently performed by incorporating the minimum value and the maximum value of the DR used to represent a scene.

Therefore, in an embodiment, an opto-electrical transfer method for an HDR video based on a visual perception model adaptive to the luminance range and surround luminance of an image may be disclosed. Also, an electro-optical transfer method that is the reverse process of such an opto-electrical transfer method may be presented.

By means of the electro-optical transfer and/or opto-electrical transfer for an HDR video according to the embodiment, even if a 10-bit depth is used, degradation of image quality may not occur, and an HDR video may be represented such that optimal image quality is provided using a smaller number of bits.

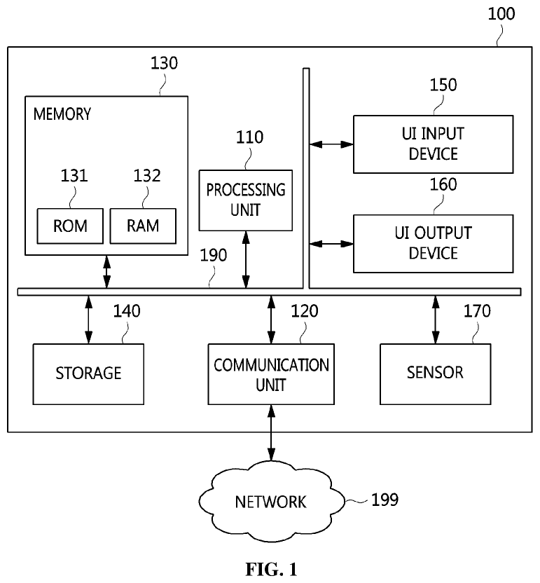

FIG. 1 illustrates an encoding apparatus according to an embodiment.

An encoding apparatus 100 may include at least some of a processing unit 110, a communication unit 120, memory 130, storage 140, and a bus 190. The components of the encoding apparatus 100, such as the processing unit 110, the communication unit 120, the memory 130, and the storage 140, may communicate with each other through the bus 190.

The processing unit 110 may be a semiconductor device for executing processing instructions stored in the memory 130 or the storage 140. For example, the processing unit 110 may be at least one hardware processor.

The processing unit 110 may process tasks required for the operation of the encoding apparatus 100. The processing unit 110 may execute code in the operations or steps of the processing unit 110, which will be described in connection with the embodiments.

The processing unit 110 may generate, store, and output information to be described in the embodiments, which will be described later, and may perform operations at other steps to be performed by the encoding apparatus 100.

The communication unit 120 may be connected to a network 199. The communication unit 120 may receive data or information required for the operation of the encoding apparatus 100, and may transmit data or information required for the operation of the encoding apparatus 100. The communication unit 120 may transmit data to an additional device and receive data from the additional device over the network 199. For example, the communication unit 120 may be a network chip or a port.

Each of the memory 130 and the storage 140 may be any of various types of volatile or nonvolatile storage media. For example, the memory 130 may include at least one of Read-Only Memory (ROM) 131 and Random Access Memory (RAM) 132. The storage 140 may include an embedded storage medium, such as RAM, flash memory, and a hard disk, and a removable storage medium, such as a memory card.

The functions or operations of the encoding apparatus 100 may be performed when the processing unit 110 executes at least one program module. The memory 130 and/or the storage 140 may store at least one program module. The at least one program module may be configured to be executed by the processing unit 110.

At least some of the above-described components of the encoding apparatus 100 may be at least one program module.

The program modules may be included in the encoding apparatus 100 in the form of an Operating Systems (OS), application modules, libraries, and other program modules, and may be physically stored in various known storage devices. Further, at least some of the program modules may be stored in a remote storage device that enables communication with the encoding apparatus 100. Meanwhile, the program modules may include, but are not limited to, a routine, a subroutine, a program, an object, a component, and a data structure for performing specific operations or specific tasks according to an embodiment or for implementing specific abstract data types.

The encoding apparatus 100 may further include a User Interface (UI) input device 150 and a UI output device 160. The UI input device 150 may receive user input required for the operation of the encoding apparatus 100. The UI output device 160 may output information or data depending on the operation of the encoding apparatus 100.

The encoding apparatus 100 may further include a sensor 170.

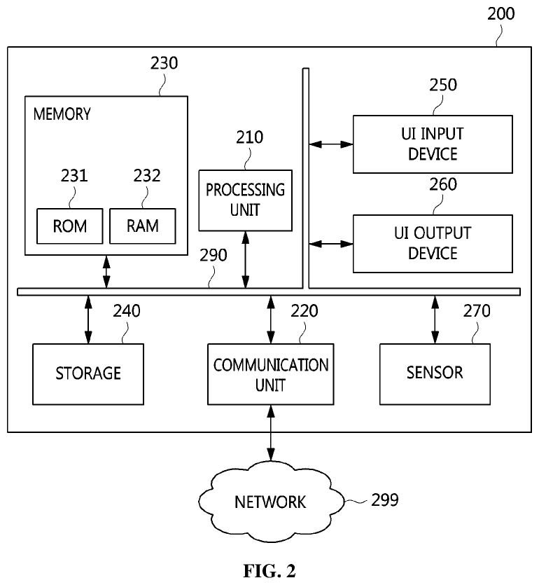

FIG. 2 illustrates a decoding apparatus according to an embodiment.

A decoding apparatus 200 may include at least some of a processing unit 210, a communication unit 220, memory 230, storage 240, and a bus 290. The components of the decoding apparatus 200, such as the processing unit 210, the communication unit 220, the memory 230, and the storage 240, may communicate with each other through the bus 290.

The processing unit 210 may be a semiconductor device for executing processing instructions stored in the memory 230 or the storage 240. For example, the processing unit 210 may be at least one hardware processor.

The processing unit 210 may process tasks required for the operation of the decoding apparatus 200. The processing unit 210 may execute code in the operations or steps of the processing unit 210, which will be described in connection with the embodiments.

The processing unit 210 may generate, store, and output information to be described in connection with the embodiments, which will be described later, and may perform operations at other steps to be performed by the decoding apparatus 200.

The communication unit 220 may be connected to a network 299. The communication unit 220 may receive data or information required for the operation of the decoding apparatus 200, and may transmit data or information required for the operation of the decoding apparatus 200. The communication unit 220 may transmit data to an additional device and receive data from the additional device over the network 299. For example, the communication unit 220 may be a network chip or a port.

Each of the memory 230 and the storage 240 may be any of various types of volatile or nonvolatile storage media. For example, the memory 230 may include at least one of ROM 231 and RAM 232. The storage 240 may include an embedded storage medium, such as RAM, flash memory, and a hard disk, and a removable storage medium, such as a memory card.

The functions or operations of the decoding apparatus 200 may be performed when the processing unit 210 executes at least one program module. The memory 230 and/or the storage 240 may store at least one program module. The at least one program module may be configured to be executed by the processing unit 210.

At least some of the components of the decoding apparatus 200 may be at least one program module.

The program modules may be included in the decoding apparatus 200 in the form of Operating Systems (OSs), application modules, libraries, and other program modules, and may be physically stored in various known storage devices. Further, at least some of the program modules may be stored in a remote storage device that enables communication with the decoding apparatus 200. Meanwhile, the program modules may include, but are not limited to, a routine, a subroutine, a program, an object, a component, and a data structure for performing specific operations or specific tasks according to an embodiment or for implementing specific abstract data types.

The decoding apparatus 200 may further include a User Interface (UI) input device 250 and a UI output device 260. The UI input device 250 may receive user input required for the operation of the decoding apparatus 200. The UI output device 260 may output information or data depending on the operation of the decoding apparatus 200.

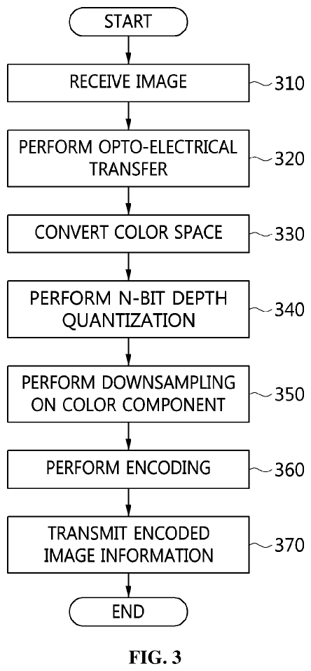

FIG. 3 is a flowchart of video encoding according to an embodiment.

Video encoding according to the embodiment may be performed by the encoding apparatus 100. Video encoding according to an embodiment may be regarded as a video-processing method (or an image-processing method). Further, the encoding apparatus 100 may be regarded as a video-processing apparatus (or an image-processing apparatus).

At step 310, the sensor 170 may receive an image. Here, the image may indicate one or more of multiple images constituting an HDR video. The image may include optical signals corresponding to red (R), green (G), and blue (B). In other words, the image may be composed of RGB optical signals.

At step 320, the processing unit 110 may perform opto-electrical transfer on the image using an Opto-Electrical Transfer Function (OETF). The processing unit 110 may convert the optical signal of the image into an electrical signal through opto-electrical transfer that uses an OETF. Alternatively, the processing unit 110 may generate an electrical signal indicating the image using an optical signal indicating the image through an opto-electrical transfer that uses an OETF.

The results of the OETF may be dependent on the surround luminance of the image. The OETF may be a luminance-adaptive transfer function. In other words, the OETF may be based on a CSF depending on the surround luminance of the image. Further, the results of the OETF may be dependent on the luminance range of the image. A detailed description related to the surround luminance and the luminance range will be made later.

At step 330, the processing unit 110 may convert a color space of the image. The processing unit 110 may convert the color space of the image from an RGB space into a YCbCr space. Alternatively, the processing unit 110 may convert the color space of the electrical signal indicating the image from an RGB space into a YCbCr space.

In an embodiment, YCbCr may be an example of a color space. In the description of the embodiment, YCbCr may be replaced with YUV or ICtCp.

At step 340, the processing unit 110 may perform N-bit depth quantization on the image. The processing unit 110 may convert a real number indicating the image into an integer through quantization.

For example, N may be 10 or 12.

Through quantization, a quantized integer signal may be generated from a floating-point number signal indicating the image. Alternatively, through quantization, an electrical signal indicating an image may be converted into a digital signal indicating the image.

Here, a real number and an integer may be the values of YCbCr.

At step 350, the processing unit 110 may perform downsampling on the color component (or color signal) of the image. The processing unit may convert the YCbCr format of the image from a 4:4:4 format into a 4:2:0 format by means of downsampling.

Such downsampling on the color component may be performed in consideration of the characteristics of human visual perception, which is more sensitive to brightness (luminance) than to colors.

At step 360, the processing unit 110 may generate encoded image information by encoding the image. Here, encoding may include a typical encoding method or the like, which uses a codec for the image. The processing unit 110 may generate a bitstream including the encoded image information generated by encoding the image.

The encoded image information may be a compressed digital signal indicating the image.

At step 370, the communication unit 120 may transmit the encoded image information or the bitstream including the encoded image information to the decoding apparatus 200.

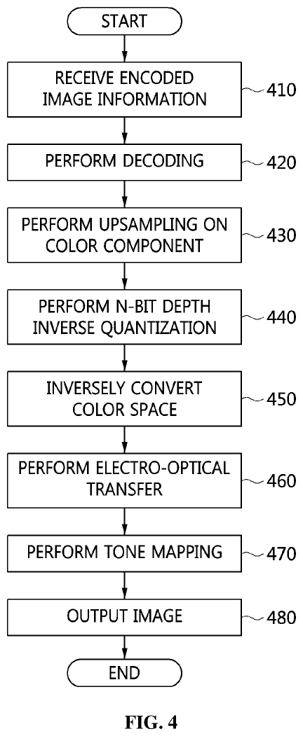

FIG. 4 is a flowchart of video decoding according to an embodiment.

Video decoding according to the embodiment may be performed by the decoding apparatus 200. Video decoding according to an embodiment may be regarded as a video-processing method (or an image-processing method). Further, the decoding apparatus 200 may be regarded as a video-processing apparatus (or an image-processing apparatus).

At step 410, the communication unit 220 may receive encoded image information or a bitstream including the encoded image information from the encoding apparatus 100.

At step 420, the processing unit 210 may generate an image by decoding the encoded image information. Here, decoding may include a typical decoding method or the like, which uses a codec for the image. The processing unit 210 may generate the image by decoding the encoded image information.

The processing unit 210 may reconstruct an uncompressed digital signal by decoding the encoded image information, and the reconstructed digital signal may indicate the image.

The image may be configured in a 4:2:0 YCbCr format.

In an embodiment, YCbCr may be an example of a color space. In the description of the embodiment, YCbCr may be replaced with YUV or ICtCp.

At step 430, the processing unit 210 may perform upsampling on the color component (or color signal) of the image. The processing unit may convert the YCbCr format of the image from a 4:2:0 format to a 4:4:4 format by means of upsampling.

At step 440, the processing unit 210 may perform N-bit depth inverse quantization on the image. Inverse quantization may be the reverse operation of quantization performed at the above-described step 340.

For example, N may be 10 or 12.

Through inverse quantization, a floating-point number signal indicating the image may be reconstructed from the quantized signal indicating the image. Alternatively, through inverse quantization, the digital signal indicating the image may be converted into an electrical signal indicating the image.

At step 450, the processing unit 210 may inversely convert the color space of the image. The processing unit 210 may convert the color space of the image from a YCbCr space into an RGB space. Alternatively, the processing unit 210 may convert the color space of an electrical signal indicating the image from a YCbCr space into an RGB space.

Inverse conversion may be the reverse operation of conversion performed at the above-described step 330.

At step 460, the processing unit 210 may perform electro-optical transfer on the image using an Electro-Optical Transfer Function (EOTF). The processing unit 210 may convert the electrical signal of the image into an optical signal through electro-optical transfer that uses the EOTF. Alternatively, the processing unit 210 may generate the optical signal indicating the image using the electrical signal indicating the image through an electro-optical transfer that uses an EOTF.

The EOTF may be the inverse function of the OETF at step 320. In an embodiment, the EOTF and the OETF may be functions corresponding to each other. Alternatively, the EOTF may be regarded as OETF⁻¹. Therefore, it can be understood that the description of one of the EOTF and the OETF is reversely applied to the other. However, a slight change may be made between the EOTF and the OETF due to an implementation issue and a digital approximation issue.

The results of the EOTF may be dependent on the surround luminance of the image. The EOTF may be a luminance-adaptive transfer function. In other words, the EOTF may be based on a CSF depending on the surround luminance of the image. Further, the results of the EOTF may be dependent on the luminance range of the image. A detailed description related to the surround luminance and the luminance range will be made later.

At step 470, the processing unit 210 may perform tone mapping on the optical signal of the image.

Tone mapping may be configured to adjust the range of the optical signal in accordance with a display via which the optical signal is to be output.

At step 480, the processing unit 210 may output the image. The processing unit 210 may output the tone-mapped optical signal of the image. Here, the image may constitute part of an HDR video.

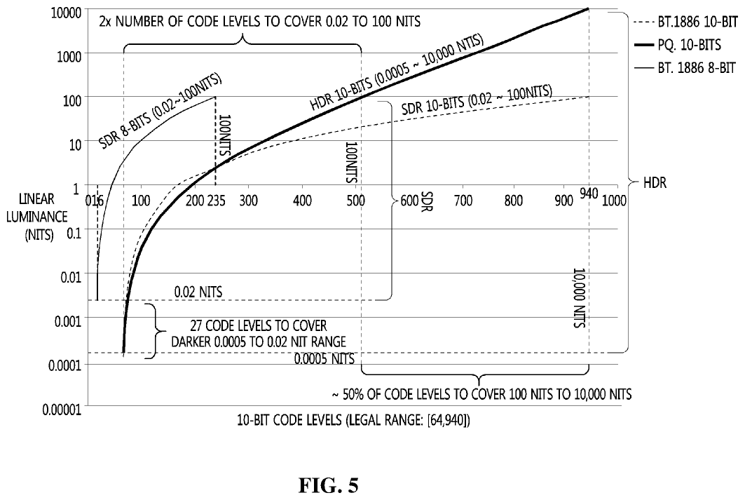

FIG. 5 is a graph illustrating a comparison between EOTFs used in a Perceptual Quantizer (PQ) and a Standard Dynamic Range (SDR) according to an example.

The horizontal axis of FIG. 5 may indicate digital code. The vertical axis of FIG. 5 may indicate luminance

FIG. 5 illustrates an EOTF in an 8-bit Standard Dynamic Range (SDR) and an EOTF in a 10-bit SDR, and also illustrates an EOTF in a 10-bit HDR (PQ).

As illustrated in FIG. 5, the PQ in HDR technology may represent a range from about 0 to 10,000.

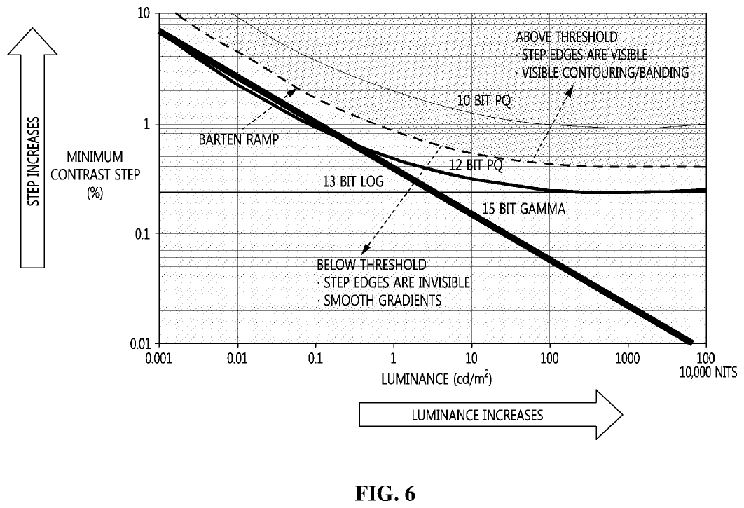

FIG. 6 illustrates the occurrence of degradation of image quality in opto-electrical transfer, which uses a 10-bit PQ and a 12-bit PQ, according to an example.

In FIG. 6, the dotted line indicates the threshold of degradation occurrence proposed by Basten.

The values of a 12-bit PQ function may be present below the threshold over the entire luminance range. These values may mean that there is no possibility that degradation of image quality will occur through opto-electrical transfer quantization using the 12-bit PQ function.

The values of the 10-bit PQ function may be present above the threshold over the entire luminance range. These values may mean that there is a possibility that degradation of image quality will occur through opto-electrical transfer quantization using the 10-bit PQ function.

As illustrated in FIG. 6, over the entire luminance range, the interval between the 12-bit PQ and the threshold may remain uniform, and the interval between the 10-bit PQ and the threshold may remain uniform. These results are obtained because the PQ function is designed to maintain a uniform interval, as illustrated in FIG. 6.

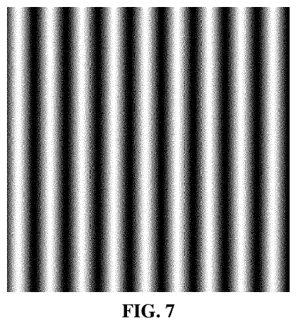

FIG. 7 illustrates a surrounding (background) area and stimuli according to an example.

In FIG. 7, a rectangular region in which a pattern is present may be a stimuli region.

The area outside the rectangular region may indicate a surrounding area. The luminance of the surrounding area may be the mean (average) of the luminance values of the surrounding area. Here, the mean may be a geometric mean.

The following Equation (1) may denote a CSF used in the PQ.

$${S}_{o} ( u , L , {X}_{o} ) = \frac{1}{{m}_{t}} \frac{{M}_{opt} ( u ) \text{/} k}{\sqrt{\frac{2}{T} ( \frac{1}{{X}_{o}^{2}} + \frac{1}{{X}_{max}^{2}} + \frac{{u}^{2}}{{N}_{max}^{2}} ) ( \frac{1}{η pE} + \frac{{Φ}_{0}}{1 - {e}^{- ( u \text{/} {u}_{0} )}} )}} \qquad ( 1 )$$

The meanings of symbols in Equation (1) may be defined as follows.

u: u may denote a spatial frequency. Here, u may change with L. Also, for u, a function Sₘₐₓ(L) may be used.

L: L may denote luminance.

Mₒₚₜ(u): Mₒₚₜ(u) may denote the optical Modulation Transfer Function (MTF) of the eye.

k: k may denote a signal-to-noise ratio (SNR).

T: T may denote the integration time of the eye.

Xₒ: Xₒ may denote the angular size of an object. Alternatively, Xₒ may denote the intensity of stimuli or a viewing angle.

Xₘₐₓ: Xₘₐₓ may denote the maximum angular size of an integration area.

Nₘₐₓ: Nₘₐₓ may denote the maximum number of cycles over which the eye can integrate pieces of information.

E: E may denote the retinal illuminance in Troland.

p: p may denote a photon conversion factor.

Φ₀: Φ₀ may denote the spectral density of neural noise.

u₀: u₀ may denote 8 cycles/degree (c/deg).

Further, symbols in Equation (1) may be defined by the following Equations (2) to (5):

$$\begin{matrix}{M}_{opt} ( u ) = {e}^{- 2 {π}^{2} {σ}^{2} {u}^{2}} & ( 2 ) \\ σ = \sqrt{{σ}_{0}^{2} + {( {C}_{ab} d )}^{2}} & ( 3 ) \\ d = 5 - 3 tanh ( 0.4 log L ) & ( 4 ) \\ E = \frac{π {d}^{2}}{4} L ( 1 - {( d \text{/} 9.7 )}^{2} + {( d \text{/} 12.4 )}^{2} ) & ( 5 )\end{matrix}$$

The following Equation (6) may denote a CSF based on surround luminance.

Sₛ(u, L, Lₛ, Xₒ)=C·Sₒ(u, L, Xₒ) (6)

Lₛ may denote surround luminance.

In other words, the CSF based on surround luminance may be represented by the product (i.e., multiplication) of an “existing CSF irrelevant to surround luminance” and a “correction factor for considering surround luminance”.

In Equation (6), the correction factor C for considering surround luminance may be defined by the following Equation (7):

$$C = exp [ - \frac{{ln}^{2} ( \frac{{L}_{s}}{L} {( 1 + 144 \text{/} {X}_{o}^{2} )}^{0.25} ) - {ln}^{2} ( {( 1 + 144 \text{/} {X}_{o}^{2} )}^{0.25} )}{2 {ln}^{2} ( 32 )} ] \qquad ( 7 )$$

The OETF at the above-described step 320 and the EOTF at the above-described step 460 may be performed based on the CSF depending on the surround luminance in Equation (2). Alternatively, the OETF and the EOTF may use the CSF based on the surround luminance in Equation (2).

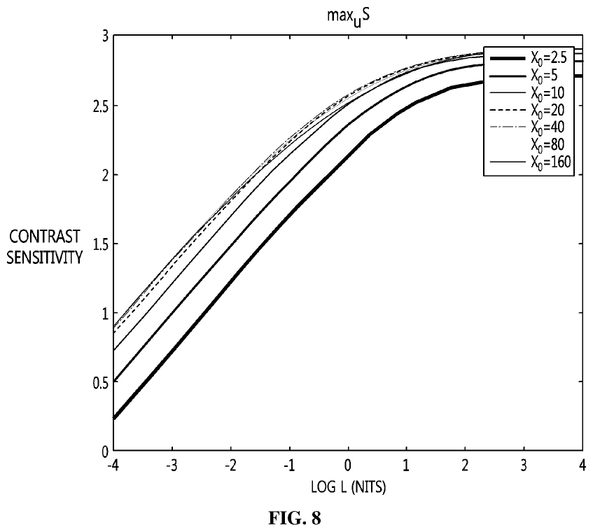

FIG. 8 illustrates contrast sensitivity depending on the intensities of stimuli according to an example.

In FIG. 8, a graph illustrating intensities of specific stimuli is depicted. Curves in FIG. 8 denote the intensities of the specific stimuli. The x axis of the graph denotes log L. The y axis of the graph denotes contrast sensitivity.

In the use of CSF, the maximum value of the CSF may be important. The CSF corresponding to the maximum value may indicate the case where a person is most sensitive to contrast.

As illustrated in FIG. 8, when Xₒ, is 40°, the CSF has the maximum value overall, and thus Xₒ, may be fixed at 40°, and a change in Xₒ, may be negligible.

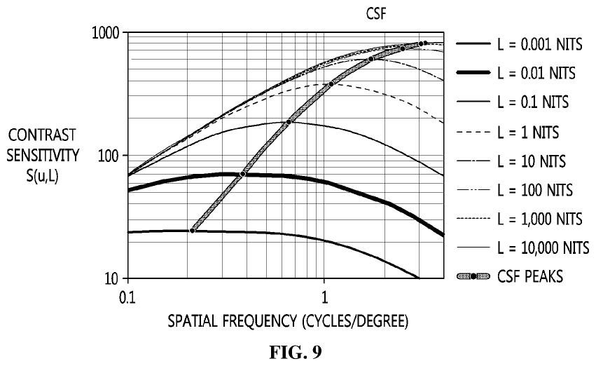

FIG. 9 illustrates contrast sensitivity depending on luminance according to an example.

In FIG. 9, a graph of specific luminance is depicted. Curves in the graph may dente specific luminance or CSF peaks. The x axis of the graph may denote a spatial frequency u. The y axis of the graph may denote contrast sensitivity S(u,L).

In the graph, each curve composed of CSF peaks may denote a max S function.

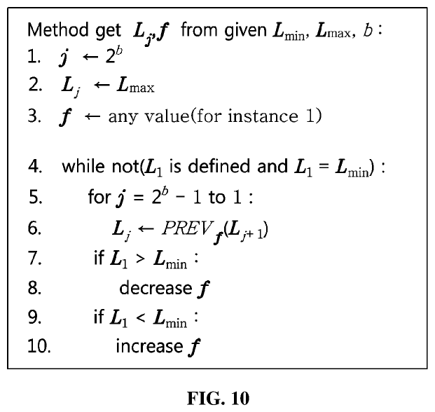

FIG. 10 illustrates pseudocode for electro-optical transfer and opto-electrical transfer according to an example.

The purpose of an Electro-Optical Transfer Function (EOTF) may be intended to prevent or minimize perceptual image quality distortion attributable to quantization in a conversion procedure when signal conversion and quantization are performed.

It may be considered that CSF indicates which luminance difference is to be allowed at the current luminance That is, the purpose of the EOTF may be considered to decrease a quantization error, caused by quantization, below a Just-Noticeable Difference (JND).

Hereinafter, the method for deriving transfer functions based on CSF will be described. Below, an EOTF may be briefly referred to as a transfer function. For convenience of description, a procedure for deriving an EOTF is described, but the description of the following transfer function may also be applied to the derivation of an OETF.

The EOTF may be defined by the following Equation (8):

F(i)=Lⱼ (8)

Here, i may denote code.

Lⱼ may be output luminance corresponding to input i.

Here, in the EOTF, it may be assumed that the minimum value of DR is Lₘᵢₙ and the maximum value of DR is Lₘₐₓ and that conversion at a b-bit depth is used.

For convenience of description, the case where the value of b is 10 will be described. At this time, i may have 1024 values ranging from 0 to 1023.

In addition, for convenience of mathematical description, j may be defined by the following Equation (9):

j=(i+1)/1024 (9)

For 10-bit depth, a function F(i) may be composed of 1024 values. Therefore, an objective to derive the function F(i) may be regarded as an objective related to progressions composed of 1024 values. That is, the progressions may correspond to the values of the EOTF.

Here, the start and end of each progression must be able to correspond to the DR, and in particular, correspondence to the maximum value of the DR, that is, Lₘₐₓ, may be important.

For convenience of description, the sequence in which progressions are derived may conform to the direction from the maximum value Lₘₐₓ to the minimum value Lₘᵢₙ.

In this case, the recurrence relation (formula) of progressions may be represented by the following Equation (10):

PREV_{ƒ}(Lⱼ)=Lⱼ₋₁ (10)

In Equation (10), j may indicate j in Equation (9). A function PREV_{ƒ}(L) may be defined by the following Equation (11):

$${PREV}_{f} ( L ) \approx L \frac{1 - {fm}_{t} ( L )}{1 + {fm}_{t} ( L )} \qquad ( 11 )$$

In Equation (11), the value of the mₜ(L) function may be the reciprocal of a CSF S(L) . In other words, the mₜ(L) function may be defined by the following Equation (12):

$${m}_{t} ( L ) = \frac{1}{S ( L )} \qquad ( 12 )$$

Further, in an embodiment, the CSF depends on the surround luminance, and thus mₜ(L) may be determined based on the above-described Equation (6).

As described above with reference to Equation (1), multiple parameters may be applied to contrast sensitivity. From the standpoint of transfer functions, under the premise that the contrast satisfies the inequation included in the following Equation (13), the CSF may be simplified as given by Equation (12) above.

$$Contrast = \frac{\vert L - {L}^{*} \vert}{L + {L}^{*}} \leq {min}_{u , {X}_{o}} \frac{1}{S ( u , \frac{L + {L}^{*}}{2} , {X}_{o} )} \qquad ( 13 )$$

The objective of Equation (13) may be replaced with the objective of the following Equation (14). In other words, the CSF, that is, S, is used as a denominator in Equation (13), and the objective of Equation (13) to find the minimum value of a formula having S as a denominator may be replaced with the objective of Equation (14) to find the maximum value of S.

$$\frac{\vert L - {L}^{*} \vert}{L + {L}^{*}} \leq \frac{1}{{max}_{u , {X}_{o}} S ( u , \frac{L + {L}^{*}}{2} , {X}_{o} )} \approx \frac{1}{{max}_{u , {X}_{o}} S ( u , L , {X}_{o} )} \qquad ( 14 )$$

Since the objective of Equation (14) is related to the maximum value of the denominator term, the difference between L and L* may be considered to be relatively small. Further, based on this consideration, L* may approximate to L.

Xₒ in the CSF may denote the intensity of the stimuli in FIG. 7. As illustrated in FIG. 8, it can be experimentally proven that Xₒ has the largest value at an angle of 40°.

When the value of Xₒ is 40°, CSFs depending on the change in u are illustrated in FIG. 9, and a contrast sensitivity peak function Sₘₐₓ(L) may be derived, as given in the following Equation (15), by connecting the peaks of the CSFs.

$${S}_{max} ( L ) = {max}_{u , {X}_{o}} S ( u , L , {X}_{o} ) \qquad ( 15 )$$

When Equation (15) is substituted into Equation (11), the previous progression may be derived. Here, when surround luminance must be taken into consideration, Equation (5) must be able to be applied as the CSF, and Sₘₐₓ(L) of Equation (15), which is the function of connected peaks, must be able to be a function of L and Lₛ.

At this time, Lₛ may be the mean of luminance values of the surrounding area of the image. For example, Lₛ may be the geometric mean of all pixel values of the image. Here, the image may be the current frame, which is the target of encoding and/or decoding, among the frames of a video.

The pseudocode illustrated in FIG. 10 may acquire all progressions using the foregoing Equations. That is, all progressions may have the relationships described or defined in the pseudocode of FIG. 10.

In the pseudocode, an interval variable ƒ may be a variable used to maintain the intervals between the progressions (or the values of the EOTF) and the threshold, described above with reference to FIG. 6, at a uniform value. In other words, the progressions corresponding to the values of the EOTF may be acquired using the interval variable ƒ, and the intervals between the progressions and the threshold may be maintained at a uniform value depending on the value of the interval variable ƒ.

For example, when the value of the variable ƒ is 1.0, the EOTF may be defined such that the value of the EOTF is equal to the threshold.

For example, when the value of the variable ƒ is less than 1.0, the EOTF may be defined such that the value of the EOTF is always less than the threshold.

For example, when the value of the variable f is greater than 1.0, the EOTF may be defined such that the value of the EOTF is always greater than the threshold.

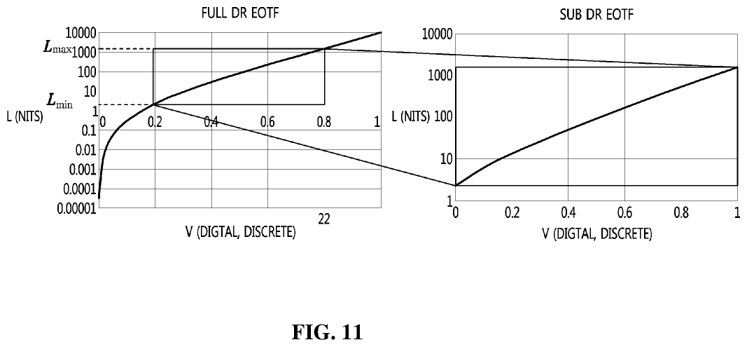

FIG. 11 illustrates transfer functions in which a luminance range is taken into consideration according to an example.

In FIG. 11, transfer functions that are derived while the luminance range of a DR is changed are illustrated, and the transfer functions derived from the luminance range of [0, 10,000] are illustrated. Further, the relationships between two transfer functions are illustrated.

As illustrated in FIG. 11, when the transfer functions are continuously represented, the function shapes of the transfer functions may have relationships in which the magnitudes of the transfer functions are changed.

Since the transfer functions are actually discrete functions, locations to which sampling is applied in the transfer functions may differ from each other.

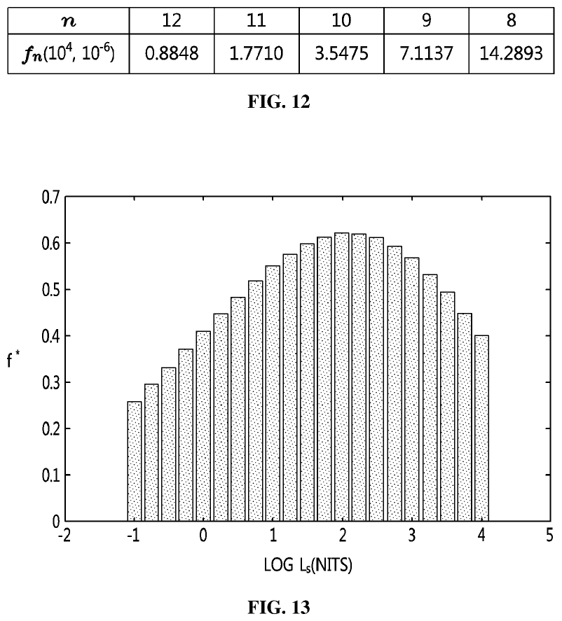

FIG. 12 illustrates a table indicating performance indices according to an example.

The performance of the scheme in a PQ and the performance of the scheme in the embodiment may be mathematically compared with each other.

An inverse function OETF “F⁻¹(L)” of the above-defined EOTF “F(j)=L” may be defined by the following Equation (16):

$${F}^{- 1} ( L ) = \frac{{2}^{- n}}{f} {\int }_{{L}_{min}}^{L} \frac{dL}{{Lm}_{t} ( L )} \qquad ( 16 )$$

Based on Equation (16), f may be represented by the following Equation (17). ƒ may be a performance index indicating whether degradation of image quality has occurred due to the transfer function.

$$f = {2}^{- n} {\int }_{{L}_{min}}^{{L}_{max}} \frac{dL}{{Lm}_{t} ( L )} \qquad ( 17 )$$

In FIG. 12, a change in the value of ƒ in a 12-bit PQ is illustrated. The value of ƒ may be measured using Equation (16). At this time, the maximum value of the DR may be 10⁴, and the minimum value of the DR may be 10⁻⁶.

Referring to the results illustrated in FIG. 12, it can be seen that conditions corresponding to the threshold of the foregoing FIG. 6 (i.e., f=1), the 12-bit PQ (i.e., ƒ<1), and the 10-bit PQ (i.e., ƒ>1) are satisfied.

FIG. 13 illustrates a change in a performance index when a transfer function is determined using a Contrast Sensitivity Function (CSF) in which surround luminance is taken into consideration.

When a transfer function is derived using the CSF function in which surround luminance is taken into consideration, the value of ƒ may be changed, as illustrated in FIG. 13. Here, the bit depth of the transfer function may be 12 bits.

As illustrated in FIG. 13, the value of ƒ in which surround luminance is taken into consideration may always be less than the value of ƒ (i.e., 0.8848) in which surround luminance is not taken into consideration. That is, it can be seen that, by means of the method according to the embodiment, the performance of electro-optical transfer and opto-electrical transfer is improved.

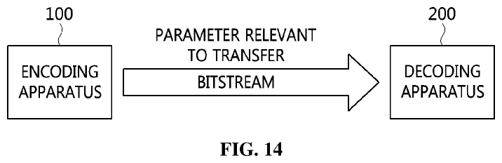

FIG. 14 illustrates parameter signaling of a luminance-adaptive transfer function according to an embodiment.

At step 320, described above with reference to FIG. 3, the processing unit 110 may derive an OETF using parameters. At step 460, described above with reference to FIG. 4, the processing unit 210 may derive an EOTF using the parameters.

The OETF and the EOTF, which are luminance-adaptive transfer functions, may be derived using parameters.

The parameters may include one or more of 1) a representation bit depth, 2) a luminance range (e.g., the maximum value Lₘₐₓ of luminance and the minimum value Lₘᵢₙ of luminance), 3) surround luminance Lₛ, and 4) a contrast sensitivity peak function Sₘₐₓ(L) in which surround luminance is taken into consideration.

Such parameters may be signaled from the encoding apparatus 100 to the decoding apparatus 200, as will be described below.

Hereinafter, signaling may mean that each parameter is transmitted from the encoding apparatus 100 to the decoding apparatus 200 through a bitstream. The bitstream may include encoded parameters.

At step 360, the processing unit 110 of the encoding apparatus 100 may generate the encoded parameters by encoding the parameters. The bitstream generated at step 360 may include the encoded parameters. Alternatively, the encoded parameters may be included in the above-described encoded image information.

The bitstream received at step 410 may include the encoded parameters. At step 420, the processing unit 210 of the decoding apparatus 200 may acquire parameters by decoding the encoded parameters.

The term “representation bit depth” may refer to the above-described bit depth. It may be assumed that the representation bit depth is not changed in the sequence of a video. Under this assumption, the representation bit depth may be transmitted only once at the start of the sequence.

The representation bit depth may be one of parameters of the sequence. For example, a Sequence Parameter Set (SPS) in a bitstream may include the representation bit depth. The representation bit depth may be signaled through the SPS.

When the representation bit depth of the video is changed, it may be considered that the sequence is changed. The term “change of the sequence” may mean that the frames of the video restart at an Instantaneous Decoding Refresh (IDR) frame. When the sequence is changed, an SPS for a new sequence attributable to the change may be transmitted through a bitstream, and a changed representation bit depth for the new sequence may be included in the SPS.

As will be described later in relation to the luminance range, luminance range unit information, a differential value, a table, an index, etc. may be used.

The luminance range may be signaled for each frame or each Group of Pictures (GOP).

The luminance range unit information may denote the unit by which a luminance range is signaled. For example, the luminance range unit information may indicate one of a frame and a GOP for which the luminance range is to be signaled. The SPS may include the luminance range unit information.

For example, when the luminance range is signaled for each frame, a slice header or a frame header may include the maximum value Lₘₐₓ of luminance and the minimum value Lₘᵢₙ of luminance.

It may be assumed that, in consecutive frames constituting a video, the change between the maximum value Lₘₐₓ of luminance and the minimum value Lₘᵢₙ of luminance is not large. The differential value of the maximum value of luminance and the differential value of the minimum value of luminance may be signaled. The differential value of the maximum value of luminance may be the difference between the maximum value of luminance of the previous frame and the maximum value of luminance of the current frame. The differential value of the minimum value of luminance may be the difference between the minimum value of luminance of the previous frame and the minimum value of luminance of the current frame.

The parameters may include the differential value of the maximum value of luminance and the differential value of the minimum value of luminance In other words, the slice header or the frame header may include the differential value of the maximum value of luminance and the differential value of the minimum value of luminance.

When the differential values are signaled, the processing unit 210 of the decoding apparatus 200 may derive the maximum value Lₘₐₓ of luminance of the current frame from the maximum value of luminance of the previous frame and the differential value of the maximum value of luminance Further, the processing unit 210 may derive the minimum value Lₘᵢₙ of luminance of the current frame from the minimum value of luminance of the previous frame and the differential value of the minimum value of luminance.

The use of the differential values may also be applied to other parameters according to an embodiment.

The encoding apparatus 100 and the decoding apparatus 200 may use a combination of the maximum value Lₘₐₓ of luminance and the minimum value Lₘᵢₙ of luminance. The encoding apparatus 100 and the decoding apparatus 200 may use a table including multiple entities of this combination. Each of the multiple entities in the table may include a specific value for the maximum value Lₘₐₓ of luminance and a specific value for the minimum value Lₘᵢₙ of luminance In other words, as the entities of the table are specified, the maximum value Lₘₐₓ and the minimum value Lₘᵢₙ of luminance may be specified.

The parameters may include indices of the multiple entities in the table. Each index may indicate any one of the multiple entities in the table. As each index is signaled, the entity indicated by the corresponding index may be specified among the multiple entities in the table, and the values in the specified entity may be used as the maximum value Lₘₐₓ of luminance and the minimum value Lₘᵢₙ of luminance

The use of the combination, entities, table, and indices may also be applied to other parameters according to embodiments.

Also, as will be described later in relation to the surround luminance Lₛ, surround luminance unit information, a differential value, a table, an index, etc. may be used.

The surround luminance Lₛ may be signaled for each frame or each Group of Pictures (GOP).

The surround luminance unit information may denote the unit by which surround luminance Lₛ is signaled. For example, the surround luminance unit information may indicate one of a frame and a GOP for which the surround luminance Lₛ is to be signaled. The SPS may include the surround luminance unit information.

For example, when surround luminance is signaled for each frame, the slice header or the frame header may include the surround luminance Lₛ.

It may be assumed that the change in the surround luminance Lₛ is not large. The differential value of the surround luminance may be signaled. The differential value of the surround luminance may be the difference between the surround luminance of the previous frame and the surround luminance of the current frame.

The parameters may include the differential value of the surround luminance. In other words, the slice header or the frame header may include the differential value of the surround luminance.

When the differential value is signaled, the processing unit 210 of the decoding apparatus 200 may derive the surround luminance Lₛ of the current frame from the surround luminance of the previous frame and the differential value of the surround luminance.

The encoding apparatus 100 and the decoding apparatus 200 may use a table including multiple entities for the surround luminance. Each of the multiple entities in the table may include a specific value for the surround luminance Lₛ. In other words, as the entity of the table is specified, the surround luminance Lₛ may be specified.

The parameters may include indices of the multiple entities in the table. Each index may indicate any one of the multiple entities in the table. As each index is signaled, the entity indicated by the corresponding index may be specified among the multiple entities in the table, and the value in the specified entity may be used as the surround luminance Lₛ.

The apparatus (device) described herein may be implemented using hardware components, software components, or a combination thereof. For example, the apparatus (device) and components described in embodiments may be implemented using one or more general-purpose or special-purpose computers, such as, for example, a processor, a controller and an Arithmetic Logic Unit (ALU), a digital signal processor, a microcomputer, a Field-Programmable Array (FPA), a Programmable Logic Unit (PLU), a microprocessor or any other device capable of responding to and executing instructions in a defined manner. A processing device may run an Operating System (OS) and one or more software applications that run on the OS. The processing device may also access, store, manipulate, process, and create data in response to execution of the software. For the purpose of simplicity, the description of a processing device is made in the singular; however, those skilled in the art will appreciated that a processing device may include multiple processing components and multiple types of processing components. For example, a processing device may include multiple processors or a processor and a controller. In addition, different processing configurations are possible, such as configurations including parallel processors.

The software may include a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software may also be distributed over network-coupled computer systems so that the software is stored and executed in a distributed fashion. In particular, the software and data may be stored in one or more computer-readable storage media.

The method according to embodiments may be implemented in the form of program instructions that can be executed through various types of computer means, and may be stored in computer-readable storage media.

The computer-readable storage media may include information used in the embodiments of the present disclosure. For example, the computer-readable storage media may include a bitstream, and the bitstream may include the information described in the embodiments of the present disclosure.

The computer-readable storage media may include non-transitory computer-readable media.

The computer-readable media may also include, alone or in combination with the program instructions, data files, data structures, and the like. The program instructions recorded on the media may be those specially designed and constructed for the purposes of the example embodiments, or may be of a kind well-known and available to those having skill in the computer software arts. Examples of the computer-readable storage media include magnetic media such as hard disks, floppy disks, and magnetic tape; optical media such as CD ROM discs and DVDs; magneto-optical media such as optical discs; and hardware devices that are specially configured to store and perform program instructions, such as read-only memory (ROM), random access memory (RAM), and flash memory. Examples of program instructions include both machine language code, such as that produced by a compiler, and files containing higher-level language code to be executable by the computer using an interpreter. The above-described hardware device may be configured to act as one or more software modules in order to perform operations in the above-described example embodiments, or vice versa.

There are provided a method and apparatus, which perform opto-electrical transfer for converting an optical signal into an electrical signal in HDR video processing.

There are provided a method and apparatus that perform opto-electrical transfer for converting an optical signal into an electrical signal in HDR video processing.

There are provided a method and apparatus that perform electro-optical transfer for converting an electrical signal into an optical signal in HDR video processing.

There are provided a method and apparatus that perform HDR opto-electrical transfer for reducing degradation of image quality based on a luminance-adaptive visual perception model.

There are provided a method and apparatus that perform HDR electro-optical transfer, which is the reverse process of HDR opto-electrical transfer.

Although exemplary embodiments have been illustrated and described above with reference to limited embodiments and drawings, it will be appreciated by those skilled in the art that various changes and modifications may be made in these exemplary embodiments without departing from the principles and spirit of the disclosure. For example, desired results can be achieved even if the described techniques are performed in an order different from that of the described methods and/or even if the components, such as the described system, architecture, device, and circuit, are coupled or combined in a form different from that of the described methods or are substituted or replaced by other components or equivalents thereof.

What is claimed is:

1. A video-processing method, comprising:
performing opto-electrical transfer on an image using an opto-electrical transfer function,
wherein a result of the opto-electrical transfer function is dependent on a surround luminance of the image.

2. The video-processing method of claim 1, wherein the opto-electrical transfer function is based on a contrast sensitivity function depending on the surround luminance of the image.

3. The video-processing method of claim 2, wherein the contrast sensitivity function depending on the surround luminance of the image is a product of a contrast sensitivity function irrelevant to the surround luminance and a correction factor for considering the surround luminance.

4. The video-processing method of claim 1, wherein the surround luminance is a mean of luminance values of a surrounding area of the image.

5. The video-processing method of claim 1, wherein the surround luminance is a geometric mean of values of all pixels of the image.

6. The video-processing method of claim 1, wherein the result of the opto-electrical transfer function is dependent on a luminance range of the image.

7. The video-processing method of claim 1, wherein progressions corresponding to values of the opto-electrical transfer function are acquired using an interval variable, and the interval variable is a variable used to maintain intervals between the progressions and a threshold at a uniform value.

8. The video-processing method of claim 1, wherein the opto-electrical transfer function is derived using a parameter.

9. The video-processing method of claim 8, wherein the parameter includes one or more of a bit depth, a luminance range, a surround luminance, and a contrast sensitivity peak function in which the surround luminance is taken into consideration.

10. The video-processing method of claim 1, further comprising transmitting a bitstream to a decoding apparatus,
wherein the bitstream comprises the parameter.

11. A video-processing method, comprising:
performing electro-optical transfer on an image using an electro-optical transfer function,
wherein a result of the electro-optical transfer function is dependent on a surround luminance of the image.

12. The video-processing method of claim 11, wherein the electro-optical transfer function is based on a contrast sensitivity function in which the surround luminance of the image is taken into consideration.

13. The video-processing method of claim 11, wherein the result of the electro-optical transfer function is dependent on a luminance range of the image.

14. The video-processing method of claim 11, wherein the surround luminance is a mean of luminance values of a surrounding area of the image.

15. The video-processing method of claim 11, wherein the surround luminance is a geometric mean of values of all pixels of the image.

16. The video-processing method of claim 11, wherein the result of the electro-optical transfer function is dependent on a luminance range of the image.

17. The video-processing method of claim 11, wherein the electro-optical transfer function is derived using a parameter.

18. The video-processing method of claim 17, wherein the parameter includes one or more of a bit depth, a luminance range, a surround luminance, and a contrast sensitivity peak function in which the surround luminance is taken into consideration.

19. The video-processing method of claim 11, further comprising receiving a bitstream from an encoding apparatus,
wherein the bitstream comprises the parameter.

20. A computer-readable storage medium storing a bitstream, the bitstream comprising a parameter, wherein:
the parameter is used to derive an electro-optical transfer function, and
electro-optical transfer is performed on an image using the electro-optical transfer function.
